(19) United States
(12) Patent Application Publication
(10) Pub. No.: US 2018/0199496 A1
(43) Pub. Date: Jul. 19, 2018

(54) AGRICULTURAL IMPLEMENT WITH BALANCED WEIGHT

(71) Applicant: CNH Industrial America LLC, New Holland, PA (US)

(72) Inventor: Robert A. Zemenchik, Kenosha, WI (US)

(73) Assignee: CNH Industrial America LLC, New Holland, PA (US)

(21) Appl. No.: 15/407,014

(22) Filed: Jan. 16, 2017

(51) Int. Cl. A01B 15/14; A01B 15/02; A01B 15/18; A01B 73/04; A01B 49/02

(52) U.S. Cl. CPC A01B 15/14; A01B 15/025; A01B 49/027; A01B 73/044; A01B 15/18

(57) ABSTRACT

An agricultural implement includes: a frame including a front frame section, a rear frame section, and a counterbalancing frame section between the front frame section and the rear frame section; a hitch connected to the front frame section; a plurality of shanks connected to the rear frame section; a plurality of residue managing assemblies connected to the front frame section and/or the counterbalancing frame section; and a ground engaging assembly connected to the frame between the counterbalancing frame section and the rear frame section and defining a fulcrum between a front side and a rear side of the frame, the front side and the rear side of the frame being substantially balanced about the fulcrum.

### BACKGROUND OF THE INVENTION

### 1. Field of the Invention

The present invention relates to agricultural implements, and, more particularly, to agricultural ripper implements.

### 2. Description of the Related Art

Farmers utilize a variety of agricultural implements to prepare soil for planting seeds that will eventually grow into harvestable crops. One particular type of implement used to prepare soil is a ripper, which alleviates soil compaction by ripping into the soil to break up the compaction layer, which is also commonly known as the “hardpan,” that can form below the top layer of the soil and inhibit root growth. Once the hardpan is broken by the ripper, plant roots are better able to spread out in the soil to search for water and nutrients, which can increase the yield of the soil by reducing competition between neighboring plants.

Typically, a ripper is pulled by a self-powered vehicle, such as a tractor, via a hitch connection to the tractor at a front of the frame of the ripper to prepare the soil. A ripper commonly includes multiple residue managing assemblies, such as coulters, that cut relatively shallow paths into the soil as the ripper travels across a field and can slice through crop residue so that shanks carried behind the coulters do not snag crop residue. The shanks can be carried by the frame “inline” in a row that extends perpendicular to the direction of travel of the ripper; in such instances, the ripper is referred to as an “inline ripper.” The shanks cut deep into the soil to break up the hardpan as the ripper travels across the field, and can be spring loaded to prevent damage when encountering a large, hard object, such as a rock.

One particular problem with known inline rippers is that the ripper often has a weight distribution heavily biased toward the rear of the ripper, which is known as being “tongue light.” The ripper being tongue light is not normally a problem when the hitch is connected to a tractor, as the connection to the tractor pulls down the front of the ripper to level the ripper, but is a significant problem when the ripper is being unhooked from the tractor or it is desired to be re-hooked to the tractor. For example, when a user unhooks the hitch from the tractor, the ripper is no longer leveled by the tractor and poses a significant safety risk to the user who may be struck by the hitch as the rear of the ripper suddenly lifts up the hitch. To avoid being struck by the hitch during unhooking, many users utilize jack stands when unhooking the hitch from a tractor to prevent the hitch from suddenly lifting, which is inconvenient and slows down the process of unhooking the ripper from the tractor. Along similar lines, a user may also have to lower all the shanks and/or front coulters to the ground prior to unhooking the hitch from the tractor. Further, it is difficult for a user to reconnect the hitch to the tractor since the weight of the rear of the ripper lifts the hitch vertically away from the level needed to connect to the tractor, requiring the user to push down the hitch.

What is needed in the art is a ripper which overcomes some of the previously described disadvantages of known rippers.

### SUMMARY OF THE INVENTION

The present invention provides an agricultural implement which includes a frame with a counterbalancing frame section to balance the frame about a fulcrum when tools are connected to the frame.

The invention in one form is directed to an agricultural implement including: a frame including a front frame section, a rear frame section, and a counterbalancing frame section between the front frame section and the rear frame section; a hitch connected to the front frame section; a plurality of shanks connected to the rear frame section; a plurality of residue managing assemblies connected to the front frame section and/or the counterbalancing frame section; and a ground engaging assembly connected to the frame between the counterbalancing frame section and the rear frame section and defining a fulcrum between a front side and a rear side of the frame, the front side and the rear side of the frame being substantially balanced about the fulcrum.

An advantage of the present invention is the counterbalancing frame section balances the frame so the frame is not tongue light when unhooked from a vehicle, reducing the safety risk to a user while unhooking the implement and not requiring the user to utilize jack stands or lower the shanks and/or residue managing assemblies prior to unhooking the implement from a vehicle.

Another advantage is the ground engaging assembly can be one or more pairs of walking tandems to float the implement stably over the field without requiring one or more gauge wheels.

Yet another advantage is one or more wing sections of the agricultural implement can also be balanced similarly to the frame to widen the implement without disrupting the weight balance of the implement.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of an embodiment of an agricultural implement formed according to the present invention connected to a tractor; and

FIG. 2 is another perspective view of the agricultural implement shown in FIG. 1.

Corresponding reference characters indicate corresponding parts throughout the several views. The exemplification set out herein illustrates one embodiment of the invention and such exemplifications is not to be construed as limiting the scope of the invention in any manner.

### DETAILED DESCRIPTION OF THE INVENTION

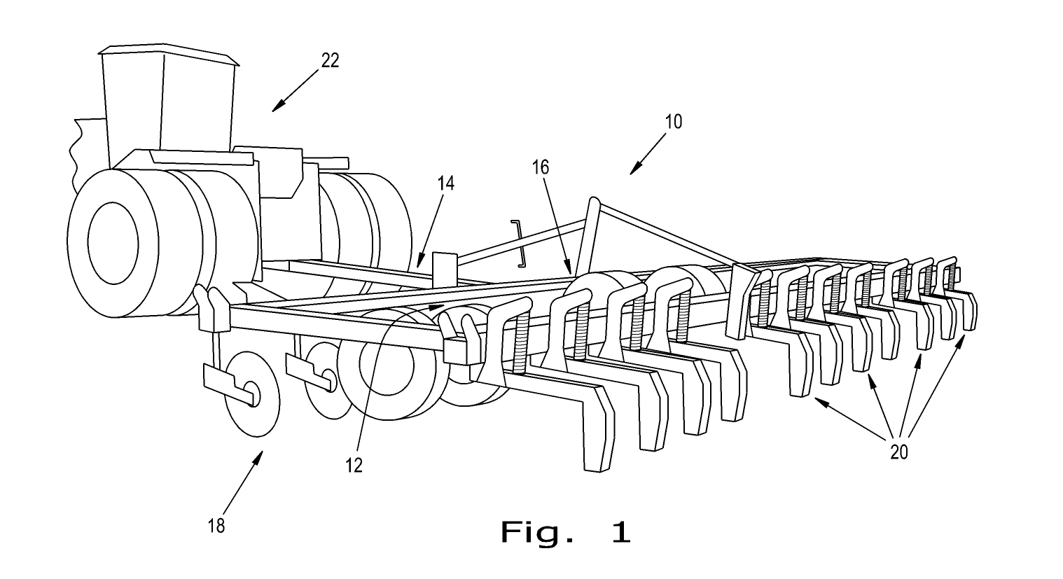

Referring now to the drawings, and more particularly to FIG. 1, there is shown an embodiment of an agricultural implement 10 which generally includes a frame 12, a hitch 14 connected to the frame 12, a ground engaging assembly 16 connected to the frame 12, a plurality of residue managing assemblies 18 connected to the frame 12, and a plurality of shanks 20 connected to the frame 12. As can be seen, the frame 12 of the implement 10 is connected to an agricultural vehicle 22, shown as a self-propelled tractor, by the hitch 14, i.e., the implement 10 is a towed implement. The tractor 22 can pull the implement 10 across a field to prepare the soil for future planting, as will be described further herein.

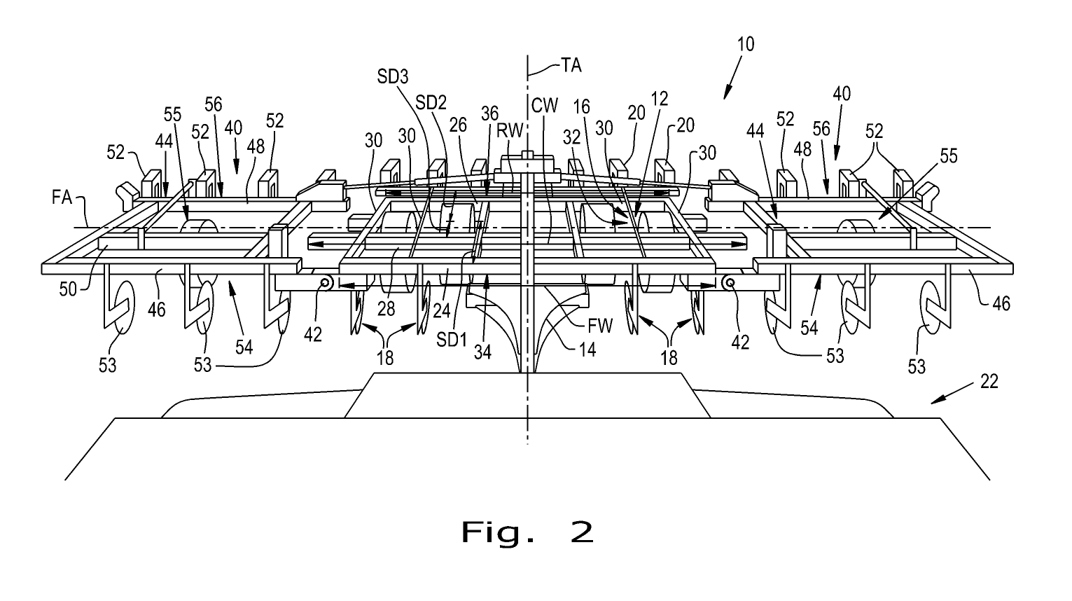

Referring now to FIG. 2, another view of the agricultural implement 10 is shown. As can be seen, the frame 12 includes a front frame section 24 which is connected to the hitch 14, a rear frame section 26 which is connected to the shanks 20, and a counterbalancing frame section 28 between the front frame section 24 and rear frame section 26. As shown, the hitch 14 can be integrally formed with the front frame section 24 such that the hitch 14 cannot be detached from the front frame section 24 without disassembly of the hitch 14 to ensure a rigid connection between the hitch 14 and the front frame section 24. Since the hitch 14 is what is connected to and pulled by the tractor 22, the hitch 14 defines a travel axis TA therethrough along which the implement 10 will travel as the implement 10 is pulled by the tractor 22. The front frame section 24, rear frame section 26, and counterbalancing frame section 28 can all extend perpendicular to the travel axis TA, i.e., width-wise, to carry respective tools in rows across the field. A plurality of joining sections 30 extending parallel to the travel axis TA can connect the front frame section 24, counterbalancing frame section 28, and rear frame section 26 together to form the frame 12. As shown, the front frame section 26 can define a front section width FW and the rear frame section 28 can define a rear section width RW which is equal to the front section width FW. The counterbalancing frame section 28, on the other hand, can define a counterbalancing section width CW which is greater than both the front section width FW and the rear section width RW, the significance of which will be described further herein.

As can be seen in FIGS. 1 and 2, the residue managing assemblies 18, which are shown as coulters, can be connected to the front frame section 24 and/or the counterbalancing frame section 28 so as to be carried in one or more rows across the field as the implement 10 is pulled by the tractor 22. While the residue managing assemblies 18 are shown as coulter disc blades, the residue managing assemblies 18 can be other types of tools that cut into the soil such as non-circular coulter blades, many of which are known. The coulters 18 can also be equally spaced from one another in a direction perpendicular to the travel axis TA, as is known. It should be appreciated that all of the coulters 18 can be connected to the front frame section 24 or the counterbalancing frame section 28, if desired, so long as the weight of the frame 12 is substantially balanced, as will be described further herein.

The shanks 20 can all be connected to the rear frame section 26 such that the shanks 20 are “inline” with each other in a row across a width of the rear frame section 26. The shanks 20 can be configured, for example, as ripper shanks 20 that will dig deep into the soil in order to break up the hardpan in the field in order to prepare the soil for planting. In such a configuration, the implement 10 can be referred to as an “inline ripper,” due to the ripper shanks 20 being inline across the rear frame section 26. The ripper shanks 20 can be configured with any type of shank point, including but not limited to shovels, plows, teeth, etc., many of which are known in the art. By having the shanks 20 connected to the rear frame section 26 and the coulters 18 connected to the front frame section 24 and/or counterbalancing frame section 28, the coulters 18 can cut a relatively shallow pit into sections of the soil prior to the shanks 20 traveling across the section, as is known.

To allow the implement 10 to be efficiently towed across the field, the implement 10 has a ground engaging assembly 16 connected to the frame 12 between the counterbalancing frame section 28 and the rear frame section 26 that will contact the soil as the implement 10 is pulled by the tractor 22. As shown in FIG. 2, the ground engaging assembly 16 can include a pair of walking tandems 32 which are aligned with each other in a direction perpendicular to the travel axis TA. The walking tandems 32 can be of any suitable configuration, such as the walking tandems described in U.S. Patent Application Publication No. 2015/0125102 to Blunier et al., which is incorporated herein by reference. It should be appreciated that the ground engaging assembly 16 can include other types of ground engaging members, such as gauge wheels, if desired.

Since the ground engaging assembly 16 contacts the ground, the ground engaging assembly 16 defines a fulcrum between a front side 34 and a rear side 36 of the frame 12. Typically, the shanks of an inline ripper are significantly heavier than the residue managing assemblies, especially if the shanks are spring-loaded to prevent damage when contacting objects such as rocks. Due to the shanks being heavier than the residue managing assemblies, the frames of typical inline rippers have a weight distribution heavily slanted toward the rear side of the frame, which biases the rear side of the frame to tilt downwardly about the fulcrum and lift the front side, as previously described. To counteract weight imbalance caused by the shanks 20 being relatively heavier than the residue managing assemblies 18, the frame 12 according to the present invention incorporates the counterbalancing frame section 28 to offset the combined weight difference between the residue managing assemblies 18 and the shanks 20 such that the front side 34 and the rear side 36 of the frame 12 are substantially balanced about the fulcrum. As used herein, “substantially balanced” should be understood to mean that the frame 12, when the implement 10 is unhooked from a vehicle, is generally level, with a slant of the frame 12 from the front side 34 to the rear side 36, relative to the ground, being no more than 5°. In this sense, the counterbalancing frame section 28 acts as a counterbalance to the combined weight of the rear frame section 26 and connected shanks 20 to balance the frame 12 about the fulcrum defined by the ground engaging assembly 16.

The counterbalancing frame section 28 can act as a counterbalance in a variety of ways. For example, the counterbalancing frame section 28 can be formed as a frame tube with similar dimensions to frame tubes forming the front frame section 24 and the rear frame section 26, except for the counterbalancing frame section 28 having the counterbalance section width CW which is greater than both the front section width FW and the rear section width RW, as previously described. In such a configuration, the weight of the counterbalancing frame section 28 can counteract the difference in weight between the shanks 20 and the residue managing assemblies 18 to substantially balance the front side 34 and rear side 36 about the fulcrum. It should be appreciated that the counterbalancing frame section 28 can also have a counterbalance section width which is less than the width of the front frame section 24 and/or the rear frame section 26, as the weight of the counterbalancing frame section 28 can counterbalance the weight of the rear frame section 26 and shanks 20 so long as the counterbalancing frame section 28 is sufficiently weighted on the front side 34 of the frame 12. In other words, the front frame section 24 and residue managing assemblies 18 can have a front combined moment relative to the fulcrum which is defined by the combined weight of the front frame section 24 and connected residue managing assemblies 18 multiplied by a shortest distance SD1 between the front frame section 24 and the fulcrum. Similarly, the rear frame section 26 and shanks 20 can have a rear combined moment relative to the fulcrum which is defined by the combined weight of the rear frame section 26 and connected shanks 20 multiplied by a shortest distance SD2 between the rear frame section 26 and the fulcrum, with the rear combined moment being greater than the front combined moment. To balance the front side 34 of the frame 12 and the rear side 36 of the frame 12 about the fulcrum, the counterbalancing frame section 28 can have a counterbalance moment defined by the combined weight of the counterbalancing frame section 28 and connected residue managing assemblies 18 multiplied by a shortest distance SD3 between the counterbalancing frame section 28 and the fulcrum. Thus, the counterbalancing frame section 28 can be distanced from the fulcrum and weighted such that no net moment is produced on either side of the fulcrum, balancing the frame 12.

To increase the effective width of the implement 10, one or more wing sections 40 can be hingedly connected to the frame 12 by a hinge 42. Each wing section 40 can include a wing frame 44 having a front wing section 46, a rear wing section 48, and a counterbalancing wing section 50 between the front wing section 46 and rear wing section 48, similar to the frame 12. A plurality of wing shanks 52, such as ripper shanks, can be connected to the rear wing section 48 and a plurality of wing residue managing assemblies 53, such as coulter discs, can be connected to the front wing section 46 and/or counterbalancing wing section 50. The wing section(s) 40 can each also include a wing ground engaging assembly 55, such as a walking tandem, connected to the wing frame 44 and defining a wing fulcrum between a front side 54 and a rear side 56 of the wing section 40. Each wing section 40 can be substantially balanced about the wing fulcrum similarly to the rest of the implement 10, i.e., by weighting and distancing the counterbalancing wing section 50 from the wing fulcrum such that no net moment is produced on either side of the fulcrum. By having one or more balanced wing sections 40, the effective width of the implement 10 can be increased during operation, with the wing section(s) 40 being folded about the hinge 42 to reduce the width of the implement 10 when, for example, the implement 10 is traveling on public roadways. To help maintain balance of the implement 10 during travel, the ground engaging assembly 16 connected to the frame 12 and the wing ground engaging assembly 52 of the wing section(s) 40 can be aligned on a fulcrum axis FA which extends perpendicular to the travel axis TA so that when the wing section(s) 40 folds about the hinge(s) 42 over the frame 12, the folded wing section(s) 40 does not produce a net moment on either side of the fulcrum of the frame 12.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural implement, comprising:
a frame including a front frame section, a rear frame section, and a counterbalancing frame section between said front frame section and said rear frame section;
a hitch connected to said front frame section;
a plurality of shanks connected to said rear frame section;
a plurality of residue managing assemblies connected to at least one of said front frame section and said counterbalancing frame section; and
a ground engaging assembly connected to said frame between said counterbalancing frame section and said rear frame section and defining a fulcrum between a front side and a rear side of said frame, said front side and said rear side of said frame being substantially balanced about said fulcrum.

2. The agricultural implement according to claim 1, wherein said hitch defines a travel axis and said front frame section, said rear frame section, and said counterbalancing frame section extend perpendicular to said travel axis.

3. The agricultural implement according to claim 1, wherein said ground engaging assembly includes at least one pair of walking tandems.

4. The agricultural implement according to claim 3, wherein said at least one pair of walking tandems comprises a plurality of pairs of walking tandems.

5. The agricultural implement according to claim 1, wherein said plurality of residue managing assemblies comprises a plurality of coulters.

6. The agricultural implement according to claim 1, wherein said hitch is integrally formed with said front frame section.

7. The agricultural implement according to claim 1, further comprising at least one wing section connected to said frame, said at least one wing section including:
a wing frame including a front wing section, a rear wing section, and a counterbalancing wing section between said front wing section and said rear wing section;
a plurality of wing shanks connected to said rear wing section;
a plurality of wing residue managing assemblies connected to at least one of said front wing section and said counterbalancing wing section; and
a wing ground engaging assembly connected to said wing frame between said counterbalancing wing section and said rear wing section and defining a wing fulcrum between a front side and a rear side of said at least one wing section, said front side and said rear side of said at least one wing section being substantially balanced about said wing fulcrum.

8. The agricultural implement according to claim 7, wherein said at least one wing section is hingedly connected to said frame.

9. The agricultural implement according to claim 1, wherein said counterbalancing frame section defines a counterbalancing section width and said front frame section defines a front section width which is less than said counterbalancing section width.

10. The agricultural implement according to claim 9, wherein said rear frame section defines a rear section width which is equal to said front section width.

11. The agricultural implement according to claim 1, wherein at least one of said front frame section, said rear frame section, and said counterbalancing frame section is a frame tube.
